(19) United States
(12) Patent Application Publication
(10) Pub. No.: US 2025/0260422 A1
(43) Pub. Date: Aug. 14, 2025

(54) Wearable Computing Device Having Multiple Antennas for Communication Diversity

(71) Applicant: Google LLC, Mountain View, CA (US)

(72) Inventors: Maryam Tabesh, San Francisco, CA (US); Zheyu Wang, San Jose, CA (US); Vivek Tulshiram Bharambe, San Jose, CA (US)

(21) Appl. No.: 18/854,899

(22) PCT Filed: Apr. 14, 2022
(86) PCT No.: PCT/US2022/024786

§ 371 Date: Oct. 7, 2024

(51) Int. Cl. H04B 1/00; H04B 1/04; H04B 1/3827; H04B 7/04

(52) U.S. Cl. CPC H04B 1/006; H04B 1/0483; H04B 1/385; H04B 7/04; H04B 2001/3861

(57) ABSTRACT

Systems and methods for controlling wireless data transmissions in a wearable computing device are disclosed herein. The method can include receiving a first signal associated with one of a primary antenna or a diversity antenna and receiving a second signal associated with the other of the primary antenna or the diversity antenna. The method can also include comparing the first signal and the second signal to determine whether the second signal is indicative of the one of the primary antenna or the diversity antenna having a stronger signal reception and, if the second signal is indicative of a stronger signal reception strength, generating a control signal for a switching device to perform a switching operation including disconnecting the one of the primary antenna or the diversity antenna from a primary communication path and connecting the other of the primary antenna or the diversity antenna to the primary communication path.

### FIELD

The present disclosure relates generally to wearable computing devices. More particularly, the present disclosure relates to a wearable computing device having multiple (e.g., two) antennas for communication diversity.

### BACKGROUND

A wearable computing device (e.g., wrist watches) can wirelessly communicate with other computing devices over a variety of wireless communication standards, such as long-term evolution (“LTE”), Wi-Fi, Bluetooth, and the like. The wireless communication standards can cover a variety of frequency bands. The wearable computing device can include an antenna for wireless communication.

The use of one antenna for communication over every wireless communication standard can be difficult. For example, various carriers and providers of wireless communication services can require certain connectivity standards from the wearable computing device that may not be met by using only one antenna to wireless communicate. Furthermore, the use of only one antenna can make the wearable computing device susceptible to antenna desensitivity (e.g., radio frequency chain desensitization), or degradation in antenna sensitivity due to noise sources, such as other electronic components of the wearable computing device or other noise sources. Accessories for the wearable computing device (e.g., metal bands for wearing the wearable computing device around the wrist), and the like can also change radiation patterns of an antenna and cause sensitivity degradation.

### SUMMARY

Aspects and advantages of embodiments of the present disclosure will be set forth in part in the following description, or can be learned from the description, or can be learned through practice of the embodiments.

In one embodiment, a wearable computing device can be provided. The wearable computing device can include a primary antenna disposed at a first location at the wearable computing device; a diversity antenna disposed at a second location at the wearable computing device, the second location being different than the first location; and a switching device electrically coupled to the primary antenna and the diversity antenna. The wearable computing device can also include one or more processors and a non-transitory, computer-readable memory comprising instructions that, when executed by the one or more processors, causes the one or more processors to perform a process. The process can include receiving a first signal associated with one of the primary antenna or the diversity antenna and receiving a second signal associated with the other of the primary antenna or the diversity antenna. The process can also include comparing the first signal and the second signal to determine whether the second signal is indicative of the one of the primary antenna or the diversity antenna having a stronger signal reception than the other of the primary antenna or the diversity antenna and responsive to determining that second signal is indicative of a stronger signal reception strength than the first signal, generating a control signal for the switching device to perform a switching operation, the switching operation including disconnecting the one of the primary antenna or the diversity antenna from a primary communication path and connecting the other of the primary antenna or the diversity antenna to the primary communication path.

In another embodiment, a method for controlling wireless data transmissions in a wearable computing device can be provided. The method can include receiving a first signal associated with one of a primary antenna or a diversity antenna and receiving a second signal associated with the other of the primary antenna or the diversity antenna. The method can also include comparing the first signal and the second signal to determine whether the second signal is indicative of the one of the primary antenna or the diversity antenna having a stronger signal reception than the other of the primary antenna or the diversity antenna, and responsive to determining that second signal is indicative of a stronger signal reception strength than the first signal, generating a control signal for a switching device to perform a switching operation, the switching operation including disconnecting the one of the primary antenna or the diversity antenna from a primary communication path and connecting the other of the primary antenna or the diversity antenna to the primary communication path.

In a further embodiment, a non-transitory, computer-readable medium can be provided. The non-transitory, computer-readable medium can comprise instructions that, when executed by one or more processors, cause the one or more processors to perform a process. The process can include receiving a first signal associated with one of a primary antenna or a diversity antenna and receiving a second signal associated with the other of the primary antenna or the diversity antenna. The process can also include comparing the first signal and the second signal to determine whether the second signal is indicative of the one of the primary antenna or the diversity antenna having a stronger signal reception than the other of the primary antenna or the diversity antenna and, responsive to determining that second signal is indicative of a stronger signal reception strength than the first signal, generating a control signal for a switching device to perform a switching operation, the switching operation including disconnecting the one of the primary antenna or the diversity antenna from a primary communication path and connecting the other of the primary antenna or the diversity antenna to the primary communication path.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a wearable computing device according to some implementations of the present disclosure.

FIG. 2 depicts a view of components of a wearable computing device contained in a housing according to some implementations of the present disclosure.

FIG. 3 depicts a block diagram of components of an antenna selection system for a wearable computing device according to some implementations of the present disclosure.

FIG. 4 depicts a block diagram of components of an antenna selection system for a wearable computing device according to further implementations of the present disclosure.

FIG. 5 depicts a block diagram of components of a wearable computing device including an antenna selection system according to some implementations of the present disclosure.

FIG. 6 depicts a flow diagram of a method for selecting an antenna for wireless data transmission according to some implementations of the present disclosure.

FIG. 7 depicts a table and graph illustrating performance characteristics of wireless data transmission for a wearable computing device with two antennas according to some implementations of the present disclosure.

FIG. 8 depicts a table and graph illustrating performance characteristics of wireless data reception for a wearable computing device with two antennas according to some implementations of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to a wearable computing device that can be worn, for instance, on a user's wrist. The wearable computing device includes a housing and an antenna disposed within a cavity defined by the housing. In this manner, the wearable computing device and external devices (e.g., smartphone). However, the use of only one antenna in wearable computing devices can risk not meeting carrier specifications for covering all communication frequency bands (especially low-band long-term evolution (“LTE”) frequency bands), can cause antenna desensitivity, can cause interference with other functionality of wearable computing devices, and may not be able to easily integrate with accessories for wearable computing devices.

A wearable computing device according to the present disclosure can include multiple antennas positioned within the cavity defined by the housing. For instance, in some implementations, the wearable computing device can include a primary antenna configured to communicate over a plurality of different wireless communication standards (e.g., LTE, Wi-Fi, Bluetooth, etc.) for wide area networks (e.g., cellular networks), local area networks (e.g., Wi-Fi), or both. The wearable computing device can further include a diversity antenna configured to communicate over a frequency band associated with a wireless communication standard (e.g., LTE) for a cellular network. The wearable computing device can also include a separator that divides the cavity into a first portion in which the primary antenna is located and a second portion in which the diversity antenna is located. The separator, in some embodiments, can be a printed circuit board, such as printed circuit board for other electronic components of the wearable computing device (e.g., a processor, a memory, an input-output interface, a display interface circuit, a sensor circuit, and the like). Separating the antennas provides the advantage of minimizing each antenna interfering with the other antenna.

The wearable computing device can include a switching device (e.g., a double pole double throw switch) that selectively couples one of the two antennas to a wireless transmission/reception data path (a “primary communication path”) and the other of the two antennas to a wireless reception data path (a “diversity communication path”). The one or more processors can determine a signal strength of a signal received from the switching device (e.g., a signal from the primary antenna or the diversity antenna). Additionally, the one or more processors can receive a signal strength indicating the strength of the other signal (e.g., the signal from the other of the primary antenna or the diversity antenna). Based on the received signals, the one or more processors determines which of the primary antenna or the diversity antenna should be used for wireless transmission and/or reception of data from the wearable computing device to other computing devices. For example, the one or more processors can determine that the primary antenna is receiving data more optimally than the diversity antenna. Based on this determination, the one or more processors can generate a control signal for the switching device to switch to the primary antenna for wireless data transmission if, for example, the wearable computing device is currently using the diversity antenna for wireless data transmission.

By dynamically switching between two different antennas, the antenna (e.g., the primary antenna or the diversity antenna) providing better performance at the frequency band (e.g., low-band LTE) associated with the wireless communication standard for the cellular network can be selected. In this manner, a wearable computing device according to the present disclosure can meet wireless data carrier specifications and provide improved communications on the cellular network. For instance, all frequency bands associated with the wireless standard (e.g., LTE) for the cellular network can be covered and the dynamic switching capability can be used to select a better antenna for data transmission performance per frequency band which improves user experience when using the wearable computing device. Furthermore, the addition of the diversity antenna reduces interference between LTE Band 13 transmission (transmissions near 700 MHz in a bandwidth of 698 MHz to 806 MHz utilized for commercial cellular communications, among other functionality) and GPS data transmission.

The addition of the diversity antenna also helps to mitigate issues with loss of total radiated power in a transmitting antenna and desensitivity, or overload, for a receiver that causes the receiver to be less sensitive to wireless data communications, such as introducing white noise, intermodulation distortion, and the like. Because single antenna solutions do not provide an alternate pathway for communication, wearable computing devices having a single antenna are forced to operate with this antenna desensitivity. Conversely, a wearable computing device having two antennas and a switching scheme according to implementations of the present disclosure can alternate between antennas used for data transmission, which minimizes antenna desensitivity and enables better communications in between the wearable computing device and other computing systems.

Furthermore, a two-antenna solution allows the wearable computing device to combine received wireless data from both antennas, which allows for a better total isotropic sensitivity overall for the wearable computing device. The addition of a diversity antenna can also allow the wearable computing device to support certain accessories. For example, the user of the wearable computing device may wish to use a metal band or other material band to wear the wearable computing device around their wrist. The material of the band may cause interference in antennas located near the band. Therefore, having two antennas allows the wearable computing device to select a different antenna to provide certain communication services when the other antenna is receiving interference from various noise sources or when certain accessories change radiation patterns of an antenna, which can cause sensitivity degradation.

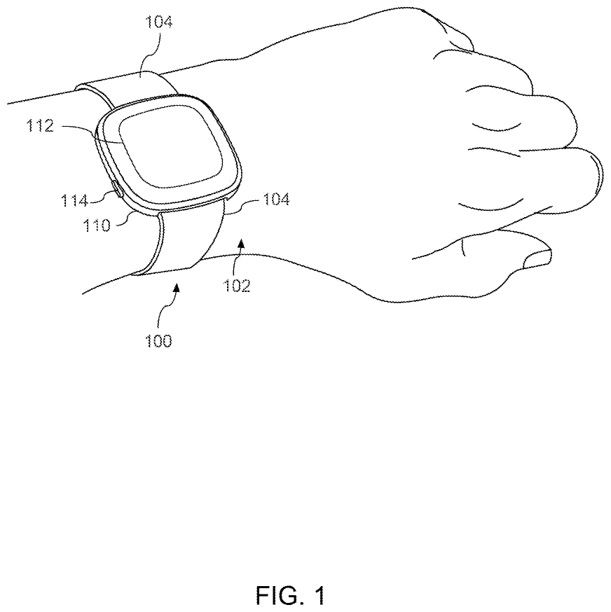

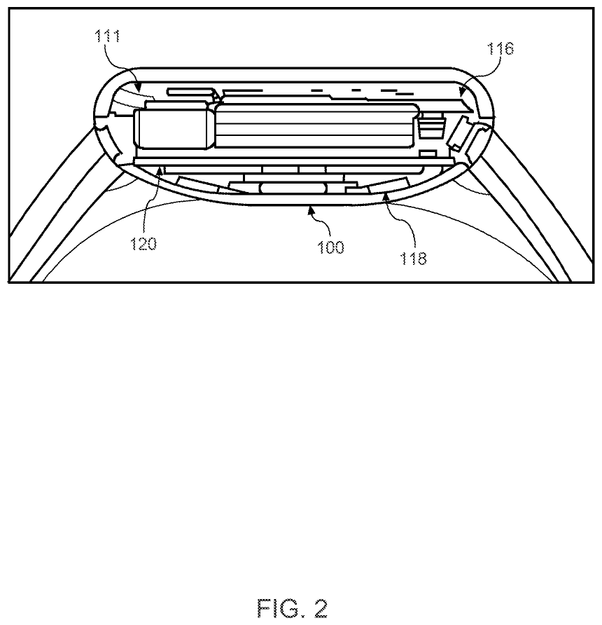

Referring now to the FIGS., FIGS. 1 and 2 depict a wearable computing device 100 according to some implementations of the present disclosure. As shown, the wearable computing device 100 can be worn, for instance, on an arm 102 (e.g., wrist) of a user. For instance, the wearable computing device 100 can include a band 104 and a housing 110. In some implementations, the housing 110 can include a conductive material (e.g., metal). In alternative implementations, the housing 110 can include a non-conductive material (e.g., a plastic material, a ceramic material).

The housing 110 can be coupled to the band 104. In this manner, the band 104 can be fastened to the arm 102 of the user to secure the housing 110 to the arm 102 of the user. Furthermore, the housing 110 can define a cavity 111 for one or more electronic components (e.g., disposed on printed circuit boards) of the wearable computing device.

In some implementations, the wearable computing device 100 can include a display screen 112. The display screen 112 can display content (e.g., time, date, biometrics, etc.) for viewing by the user. In some implementations, the display screen 112 can include an interactive display screen (e.g., touchscreen or touch-free screen). In such implementations, the user can interact with the wearable computing device 100 via the display screen 112 to control operation of the wearable computing device 100.

In some implementations, the wearable computing device 100 can include one or more input devices 114 that can be manipulated (e.g., pressed) by the user to interact with the wearable computing device 100. For instance, the one or more input devices 114 can include a mechanical button that can be manipulated (e.g., pressed) to interact with the wearable computing device 100. In some implementations, the one or more input devices 114 can be manipulated to control operation of a backlight (not shown) associated with the display screen 112. It should be understood that the one or more input device 114 can be configured to allow the user to interact with the wearable computing device 100 in any suitable manner. For instance, in some implementations, the one or more input devices 114 can be manipulated by the user to navigate through content (e.g., one or more menu screens) displayed on the display screen 112.

The wearable computing device 100 can include a primary antenna 116, a diversity antenna 118, and a separator 120. The primary antenna 116 can be an antenna configured to communicate over a plurality of different wireless communication standards (e.g., LTE, Wi-Fi, Bluetooth, etc.) for wide area networks (e.g., cellular networks), local area networks (e.g., Wi-Fi), or both. The primary antenna 116 can be located at a first location within the cavity 111 of the wearable computing device 100, such as within an upper portion of the cavity 111 near a display element of the wearable computing device 100 (e.g., near a display screen). The diversity antenna 118 can be configured to communicate over a frequency band associated with a wireless communication standard (e.g., LTE) for a cellular network. The diversity antenna 118 can be located at a second location within the cavity 111 of the wearable computing device 100, such as within a lower portion of the cavity 111 near a biometric sensor of the wearable computing device 100.

The separator 120 can divide the cavity into a first portion in which the primary antenna 116 is located (e.g., the first location) and a second portion in which the diversity antenna 118 is located (e.g., the second location). The separator 120, in some embodiments, can be a printed circuit board, such as printed circuit board for other electronic components of the wearable computing device (e.g., a processor, a memory, an input-output interface, a display interface circuit, a sensor circuit, and the like). Separating the primary antenna 116 and the diversity antenna 118 with the separator 120 provides the advantage of minimizing interference by the primary antenna 116 with the diversity antenna 118 and vice versa.

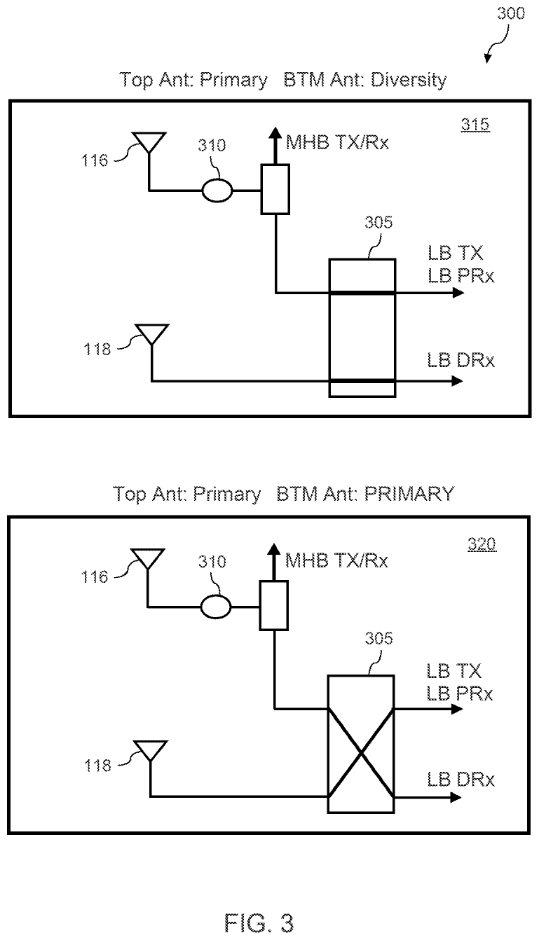

FIG. 3 depicts a block diagram of components of an antenna selection system 300 for the wearable computing device 100 according to some implementations of the present disclosure. Antenna selection system 300 can include the primary antenna 116, the diversity antenna 118, and a switching device 305.

The primary antenna 116 can wirelessly receive and transmit data for all mid and high band communications (“MHB TX/Rx”), including medium and high band LTE, Wi-Fi, Bluetooth, and other wireless communication standards. In some embodiments, the primary antenna 116 can be coupled to other components of the antenna selection system 300 via an RF connector 310, such as being electronically coupled to switching devices, one or more processors, one or more communication buses, and the like.

In some implementation, the switching device 305 can be a double-pole, double-throw switch. The switching device 305 can be electrically coupled to both the primary antenna 116 and the diversity antenna 118. The switching device 305 can also be electrically coupled to one or more processors and a signal diversity control circuit. Additional details regarding these components of the antenna selection system 300 will be discussed below.

In a first configuration 315, the switching device 305 electrically couples the primary antenna 116 to a wireless data transmission/reception path, or a primary communication path (“LB TX” and/or “LB PRx”). In the first configuration 315, the switching device 305 also electrically couples the diversity antenna 118 to a wireless data reception path, or diversity communication path (“LB DRx”). In the first configuration 315, the primary communication path allows the wearable computing device 100 to both receive data and transmit data via the primary antenna 116. Additionally, the diversity communication path allows the wearable computing device 100 to receive data via the diversity antenna 118.

In a second configuration 320, the switching device 305 electrically couples the diversity antenna 118 to the primary communication path. Additionally, the switching device 305 electrically couples the primary antenna 116 to the diversity communication path. In the second configuration 320, the primary communication path allows the wearable computing device 100 to both receive data and transmit data via the diversity antenna 118. Additionally, the diversity communication path allows the wearable computing device 100 to receive data via the primary antenna 116.

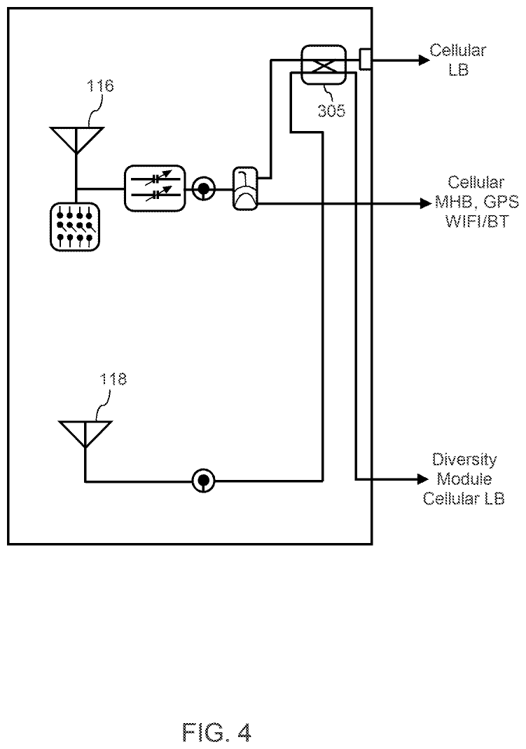

FIG. 4 depicts a block diagram of components of the antenna selection system 300 for the wearable computing device 100 according to further implementations of the present disclosure. As discussed above in relation to FIG. 3, one of the primary antenna 116 or the diversity antenna 118 is electrically coupled through the switching device 305 to one or more processors (not shown) for cellular low-band (e.g., low-band LTE) wireless data transmission and reception (“Cellular LB”). The other of the primary antenna 116 or the diversity antenna 118 is electrically coupled by the switching device 305 to a signal diversity module (not shown) that is used only for wireless data reception (“Diversity Module Cellular LB”).

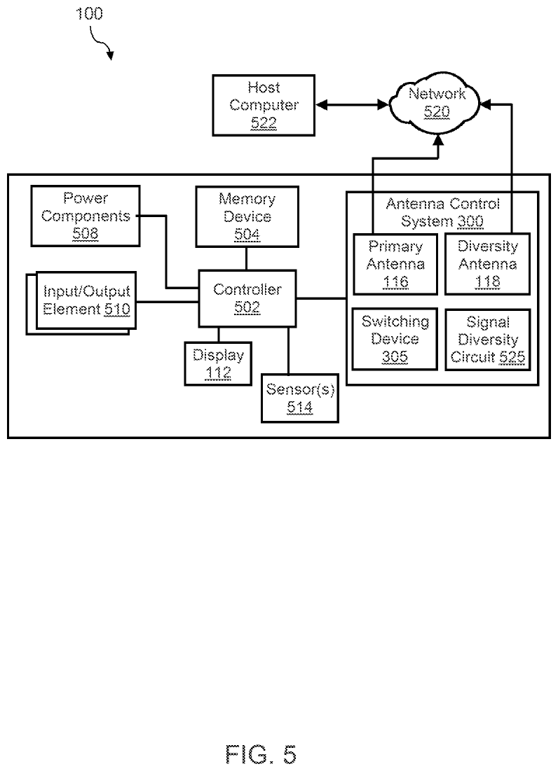

FIG. 5 depicts a block diagram of components of the wearable computing device 100 including the antenna selection system 300 according to some implementations of the present disclosure. In particular, as shown, the wearable computing device 100 may also include at least one controller 502 communicatively coupled to the sensor(s) 514 described herein. Moreover, in an embodiment, the controller(s) 502 may be a central processing unit (CPU) or graphics processing unit (GPU) for executing instructions that can be stored in a memory device 504, such as flash memory or DRAM, among other such options. For example, in an embodiment, the memory device 504 may include RAM, ROM, FLASH memory, or other non-transitory digital data storage, and may include a control program comprising sequences of instructions which, when loaded from the memory device 504 and executed using the controller(s) 502, cause the controller(s) 502 to perform the functions that are described herein.

As would be apparent to one of ordinary skill in the art, the wearable computing device 100 can include many types of memory, data storage, or computer-readable media, such as data storage for program instructions for execution by the controller or any suitable processor. The same or separate storage can be used for images or data, a removable memory can be available for sharing information with other devices, and any number of communication approaches can be available for sharing with other devices. In addition, as shown, the wearable computing device 100 includes the display screen 112, which may be a touch screen, organic light emitting diode (OLED), or liquid crystal display (LCD), although devices might convey information via other means, such as through audio speakers, projectors, or casting the display or streaming data to another device, such as a mobile phone, wherein an application on the mobile phone displays the data.

The wearable computing device 100 also includes one or more power components 508, such as may include a battery operable to be recharged through conventional plug-in approaches, or through other approaches such as capacitive charging through proximity with a power mat or other such device. In further embodiments, the wearable computing device 100 can also include at least one additional I/O device 510 able to receive conventional input from a user. This conventional input can include, for example, a push button, touch pad, touch screen, wheel, joystick, keyboard, mouse, keypad, or any other such device or element whereby a user can input a command to the wearable computing device 100. In another embodiment, the I/O device(s) 210 may be connected by a wireless infrared or Bluetooth or other link as well in some embodiments. In some embodiments, the wearable computing device 100 may also include a microphone or other audio capture element that accepts voice or other audio commands. For example, in particular embodiments, the wearable computing device 100 may not include any buttons at all, but might be controlled only through a combination of visual and audio commands, such that a user can control the wearable computing device 100 without having to be in contact therewith. In certain embodiments, the I/O elements 510 may also include one or more sensor(s) 514 such as optical sensors, barometric sensors (e.g., altimeter, etc.), and the like.

In an embodiment, the wearable computing device 100 can communicate with one or more external computers 522 over one or more networks 520 via, for example, the primary antenna 116, the diversity antenna 118, or other wireless communication components.

The wearable computing device 100 also includes the antenna selection system 300, which can include the primary antenna 116, the diversity antenna 118, the switching device 305, and a signal diversity control circuit 525. The primary antenna 116 can be an antenna designed to communicate across a variety of communication frequencies, such as wide area networks (e.g., LTE, Wi-Fi, Bluetooth, and other cellular networks), local area networks (e.g., Wi-Fi), or both. Diversity antenna 118 can be configured to communicate over a frequency band associated with a wireless communication standard (e.g., LTE) for a cellular network.

Signal diversity control circuit 525 can be electrically coupled to the wireless data reception path and the one or more processors. In some embodiments, the signal diversity control circuit 525 can receive a signal from the diversity communication path. The signal diversity control circuit can determine the signal strength of the signal received from the diversity communication path and provide this signal strength to the one or more processors for comparison to a signal strength of a signal from the primary communication path. If the signal associated with the diversity communication path has a signal strength greater than the signal strength of the signal associated with the primary communication path, the one or more processors can generate a control signal for the switching device 305, which can then disconnect the one of the primary antenna 116 and the diversity antenna 118 currently connected to the diversity communication path and connect the other antenna to the diversity communication path.

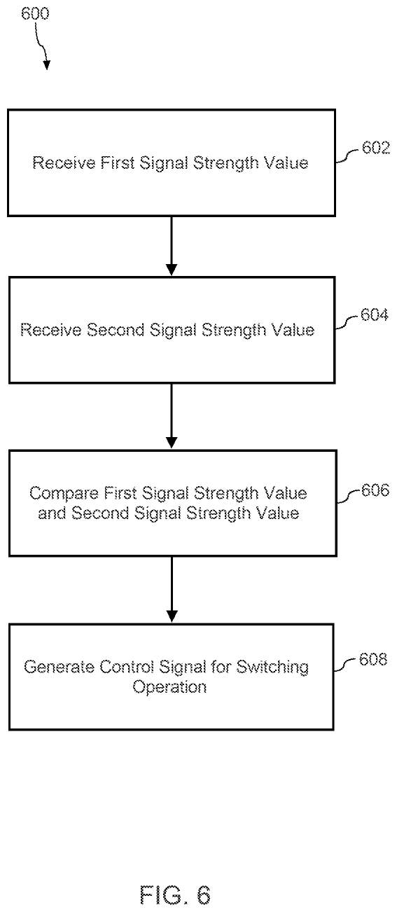

FIG. 6 depicts a flow diagram of an example method 600 of for selecting an antenna for wireless data transmission is provided according to some implementations of the present disclosure. The method 600 may be implemented using, for instance, the antenna selection system 300 discussed above with reference to FIGS. 3-5. FIG. 6 depicts steps performed in a particular order for purposes of illustration and discussion. Those of ordinary skill in the art, using the disclosures provided herein, will understand that various steps of the method 600 or any of the other methods disclosed herein may be adapted, modified, rearranged, performed simultaneously, or modified in various ways without deviating from the scope of the present disclosure.

At (602), the method 600 can include receiving, at one or more processors, a first signal having a first signal strength value. The first signal strength value can be indicative of a wireless data signal reception strength of one of the primary antenna 116 or the diversity antenna 118 based on which of the primary antenna 116 or the diversity antenna 118 is electrically coupled through the switching device 305 to the primary communication path. In some embodiments, the primary communication path is directly coupled to the one or more processors and the switching device 305.

In some embodiments, the first signal strength value is calculated by the one or more processors based on a signal received from the primary communication path. For example, the first signal strength value can be an estimated total radiated power of the one of the primary antenna 116 or the diversity antenna 118, an estimated total isotropic sensitivity of the one of the primary antenna 116 or the diversity antenna 118, or another indication of wireless data signal reception strength of the one of the primary antenna 116 or the diversity antenna 118, such as a received signal strength indicator (RSSI) or a reference signal received power (RSRP). In other embodiments, the first signal strength value can be calculated by one or more other processors or other control circuits and then be received by the one or more processors from the one or more other processors or other control circuits.

At (604), the method 600 can include receiving, at one or more processors, a second signal having a second signal strength value. The second signal strength value can be indicative of a wireless data signal reception strength of the other of the primary antenna 116 or the diversity antenna 118 based on which of the primary antenna 116 or the diversity antenna 118 is electrically coupled through the switching device 305 to the primary communication path and which of the primary antenna 116 or the diversity antenna 118 is electrically coupled to the diversity communication path.

In some embodiments, the second signal strength value is calculated by the one or more processors based on a signal received from the diversity communication path. For example, the second signal strength value can be an estimated total radiated power of the other of the primary antenna 116 or the diversity antenna 118, a total isotropic sensitivity of the other of the primary antenna 116 or the diversity antenna 118, or another indication of wireless data signal reception strength of the other of the primary antenna 116 or the diversity antenna 118. In other embodiments, the second signal strength value can be calculated by one or more other processors or other control circuits and then be received by the one or more processors from the one or more other processors or other control circuits.

For example, in some embodiments, the signal diversity control circuit 525 can be electrically coupled to the switching device 305 via the diversity communication path and can receive the signal from the diversity communication path. The signal diversity control circuit 525 can, in some embodiments, calculate the second signal strength value as a total radiated power of the other of the primary antenna 116 or the diversity antenna 118, a total isotropic sensitivity of the other of the primary antenna 116 or the diversity antenna 118, or another indication of wireless data signal reception strength of the other of the primary antenna 116 or the diversity antenna 118. The signal diversity control circuit 525 can then provide the calculated second signal strength value to the one or more processors via an electrical coupling that couples the signal diversity control circuit 525 to the one or more processors.

At (606), the method 600 can include comparing, by the one or more processors, the first signal strength value of the first signal and the second signal strength value of the second signal. In some embodiments, the comparing is performed to determine if the second signal strength value is greater than the first signal strength value. If the second signal strength value is greater than the first signal strength value, the antenna of the primary antenna 116 or the diversity antenna 118 currently connected to the diversity communication path (the wireless data reception path) is currently receiving wireless data more efficiently than the other antenna of the primary antenna 116 or the diversity antenna 118 that is currently connected to the primary communication path.

In some embodiments, the comparing is done to determine which of the antennas associated with the first signal and the second signal has the greater total radiated power, to determine which of the antennas associated with the first signal and the second signal has the greater total isotropic sensitivity, or which of the antennas associated with the first signal and the second signal has another indication of a greater wireless data reception strength.

In some embodiments, the antenna associated with the stronger wireless data reception strength is currently the antenna that is experiencing better wireless data communication with external computing devices. Therefore, it is inferred that the antenna associated with the higher wireless data reception strength will also have a higher wireless data transmission strength.

Responsive to the second signal indicating that that the other of the primary antenna 116 or the diversity antenna 118 has a greater signal reception strength, at (608), the method 600 can include generating, with the one or more processors, a control signal for the switching device 305 to perform a switching operation.

In some embodiments, the switching operation for the switching device 305 includes disconnecting the one of the primary antenna 116 or the diversity antenna 118 from the primary communication path (the wireless data transmission/reception path) because the one of the primary antenna 116 or the diversity antenna 118 has a lower wireless data reception strength. The switching operation then includes connecting the other of the primary antenna 116 or the diversity antenna 118 to the primary communication path.

The switching operation can also include disconnecting the other of the primary antenna 116 or the diversity antenna 118 from the diversity communication path (the wireless data reception path) and connecting the one of the primary antenna 116 or the diversity antenna 118 to the diversity communication path. In other words, if the antenna currently not being used to wirelessly transmit data from the wearable computing device 100 to other computing devices has a better wireless data reception strength, the one or more processors generate a switching operation for the switching device 305 to connect the antenna with the better wireless data reception strength to the primary communication path (the wireless communication path for both transmitting and receiving data) and connect the antenna with the worse wireless data reception strength to the diversity communication path (the wireless communication path used only for data reception).

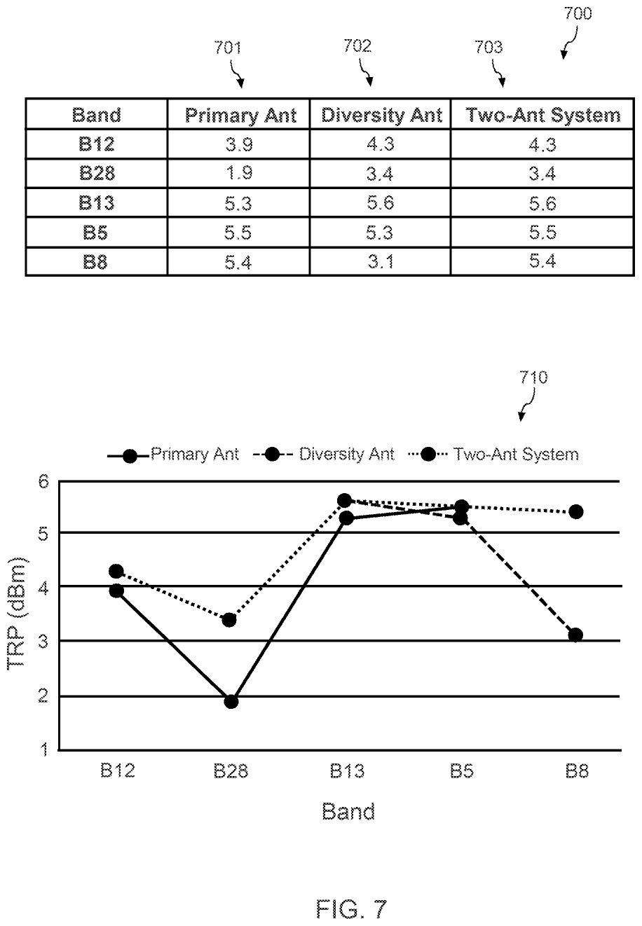

FIG. 7 depicts a table 700 and graph 710 illustrating performance characteristics of wireless data transmission for the wearable computing device 100 with two antennas according to some implementations of the present disclosure. Table 700 and graph 710 illustrate total radiated power (in decibel milliwatts) of antennas of the wearable computing device 100 in different communication frequency bands if primary antenna 116 is the only antenna used for data transmission (column 701), if diversity antenna 118 is the only antenna used for data transmission (column 702), and if the better transmitting of the two antennas is selected based on signal strengths associated with the primary antenna 116 and the diversity antenna 118 (column 703). As shown, using a two-antenna system instead of a one antenna system allows for the selection of the better-communicating antenna for data transmission in different communication frequency bands, which results in better communications for the wearable computing device 100 across the spectrum of communication frequency bands.

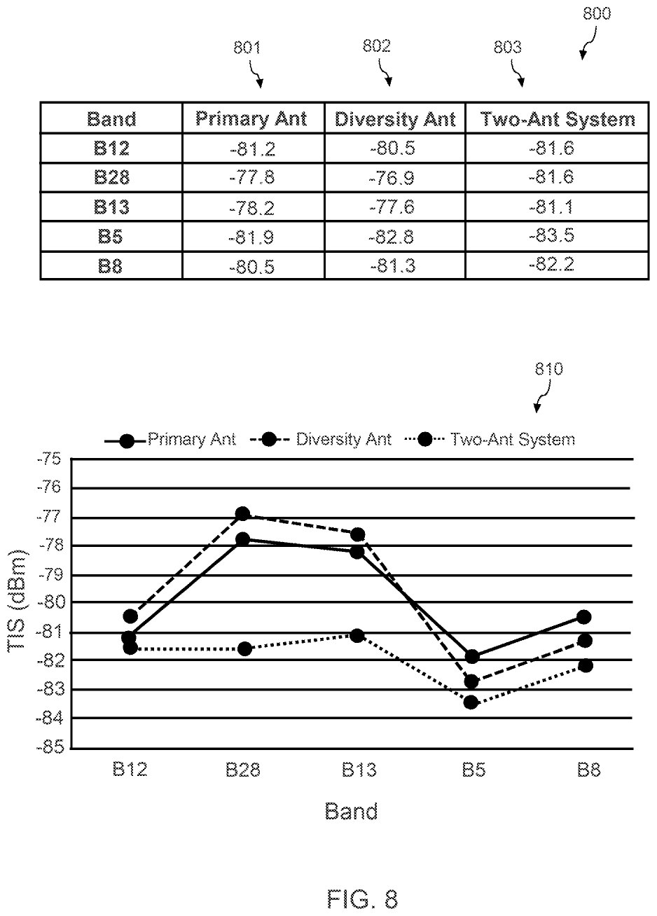

FIG. 8 depicts a table 800 and graph 810 illustrating performance characteristics of wireless data reception for the wearable computing device 100 with two antennas according to some implementations of the present disclosure. Table 800 and graph 810 illustrate total isotropic sensitivity (in decibel milliwatts) of antennas of the wearable computing device 100 in different communication frequency bands if primary antenna 116 is the only antenna used for data reception (column 801), if diversity antenna 118 is the only antenna used for data reception (column 802), and if the signals from both the primary antenna 116 and the diversity antenna 118 are combined for data reception (column 803). As shown, using a two-antenna system and combining the received signals from both antennas instead of using a one antenna system allows for better data reception for the wearable computing device 100 across the spectrum of communication frequency bands.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A wearable computing device comprising:
a primary antenna disposed at a first location at the wearable computing device;
a diversity antenna disposed at a second location at the wearable computing device, the second location being different than the first location;
a switching device electrically coupled to the primary antenna and the diversity antenna;
one or more processors; and
a non-transitory, computer-readable memory comprising instructions that, when executed by the one or more processors, causes the one or more processors to perform a process comprising:
receiving a first signal associated with one of the primary antenna or the diversity antenna;
receiving a second signal associated with the other of the primary antenna or the diversity antenna;
comparing the first signal and the second signal to determine whether the second signal is indicative of the one of the primary antenna or the diversity antenna having a stronger signal reception than the other of the primary antenna or the diversity antenna; and
responsive to determining that second signal is indicative of a stronger signal reception strength than the first signal, generating a control signal for the switching device to perform a switching operation, the switching operation including disconnecting the one of the primary antenna or the diversity antenna from a primary communication path and connecting the other of the primary antenna or the diversity antenna to the primary communication path.

2. The wearable computing device of claim 1, further comprising:
a housing defining a cavity, wherein the first location at the wearable computing device is a first location within the cavity and the second location at the wearable computing device is a second location within the cavity; and
a separator disposed within the cavity, the separator dividing the cavity into a first portion that includes the first location within the cavity and a second portion that includes the second location within the cavity.

3. The wearable computing device of claim 2, wherein the separator comprises a printed circuit board.

4. The wearable computing device of claim 1, wherein the diversity antenna is configured to communicate over a frequency band associated with a wireless communication standard for a cellular network.

5. The wearable computing device of claim 4, wherein the wireless communication standard is LTE.

6. The wearable computing device of claim 5, wherein the frequency band is a range of frequencies associated with low-band LTE.

7. The wearable computing device of claim 1, wherein the primary antenna is configured to communicate over a plurality of wireless communications standards for a cellular network and a plurality of wireless communication standards for a local area network.

8. The wearable computing device of claim 7, wherein the plurality of wireless communications standards for the cellular network includes long term evolution (LTE).

9. The wearable computing device of claim 7, wherein the plurality of wireless communications standards for the local area network includes Wi-fi and Bluetooth.

10. The wearable computing device of claim 1, wherein the first signal has a first signal strength value strength value indicating a signal reception strength from the one of the primary antenna or the diversity antenna, and wherein the second signal has a second signal strength value indicating a signal reception strength from the other of the primary antenna or the diversity antenna.

11. The wearable computing device of claim 10, wherein the first signal strength value is indicative of total radiated power of one of the primary antenna or the diversity antenna and the second signal strength value is indicative of total radiated power of the other of the primary antenna or the diversity antenna.

12. The wearable computing device of claim 10, wherein the first signal strength value is indicative of total isotropic sensitivity of one of the primary antenna or the diversity antenna and the second signal strength value is indicative of total isotropic sensitivity of the other of the primary antenna or the diversity antenna.

13. The wearable computing device of claim 1, wherein the switching operation further includes disconnecting the other of the primary antenna or the diversity antenna from a diversity communication path and connecting the one of the primary antenna or the diversity antenna to the diversity communication path.

14. The wearable computing device of claim 1, wherein the wearable computing device wirelessly receives data by combining received signals from the primary communication path and the diversity communication path.

15. The wearable computing device of claim 1, wherein the process further comprises:
receiving, at the one or more processors, a first received signal as the first signal from the switching device, wherein the signal is a signal from one of the primary antenna or the diversity antenna; and
determining, with the one or more processors, a first signal strength value for the first signal based on the first received signal.

16. The wearable computing device of claim 15, wherein the process further comprises:
receiving, at the one or more processors, a second received signal as the second signal from the other of the primary antenna and the diversity antenna; and
determining, with the one or more processors, a second signal strength value for the second signal based on the second received signal.

17. A method for controlling wireless data transmissions in a wearable computing device, the method comprising:
receiving a first signal associated with one of a primary antenna or a diversity antenna;
receiving a second signal associated with the other of the primary antenna or the diversity antenna;
comparing the first signal and the second signal to determine whether the second signal is indicative of the one of the primary antenna or the diversity antenna having a stronger signal reception than the other of the primary antenna or the diversity antenna; and
responsive to determining that second signal is indicative of a stronger signal reception strength than the first signal, generating a control signal for a switching device to perform a switching operation, the switching operation including disconnecting the one of the primary antenna or the diversity antenna from a primary communication path and connecting the other of the primary antenna or the diversity antenna to the primary communication path.

18. The method of claim 17, wherein the first signal has a first signal strength value strength value indicating a signal reception strength from the one of the primary antenna or the diversity antenna, and wherein the second signal has a second signal strength value indicating a signal reception strength from the other of the primary antenna or the diversity antenna.

19. The method of claim 18, wherein the first signal strength value is indicative of total radiated power of one of the primary antenna or the diversity antenna and the second signal strength value is indicative of total radiated power of the other of the primary antenna or the diversity antenna.

20. A non-transitory, computer-readable medium comprising instructions that, when executed by one or more processors, cause the one or more processors to perform a process, the process comprising:
receiving a first signal associated with one of a primary antenna or a diversity antenna;
receiving a second signal associated with the other of the primary antenna or the diversity antenna;
comparing the first signal and the second signal to determine whether the second signal is indicative of the one of the primary antenna or the diversity antenna having a stronger signal reception than the other of the primary antenna or the diversity antenna; and
responsive to determining that second signal is indicative of a stronger signal reception strength than the first signal, generating a control signal for a switching device to perform a switching operation, the switching operation including disconnecting the one of the primary antenna or the diversity antenna from a primary communication path and connecting the other of the primary antenna or the diversity antenna to the primary communication path.
